(19) United States
(12) Patent Application Publication
(10) Pub. No.: US 2016/0085923 A1
(43) Pub. Date: Mar. 24, 2016

(54) Method and system for identifying a potential food allergen or irritant via a communications network

(71) Applicants: Martine Lacombe, Ft Lauderdale, FL (US); Marc Michels, Ft Lauderdale, FL (US)

(72) Inventors: Martine Lacombe, Ft Lauderdale, FL (US); Marc Michels, Ft Lauderdale, FL (US)

(21) Appl. No.: 14/492,488

(22) Filed: Sep. 22, 2014

(51) Int. Cl. G06F 19/00; G06Q 50/26

(52) U.S. Cl. CPC G06F 19/326; G06Q 50/265

(57) ABSTRACT

A method and system for identifying a potential allergen/irritant from prepared food via the Internet. The allergens/irritants are selected by a user at a client system and transmitted to a server system. The server system receives (from mobile device and guest-user) or retrieves (from registered user) information including location, identification, and dietary restriction. The server system queries the restrictions against an ingredient database to determine required elimination or possible substitution. Considering received/retrieved data and server-generated parameters, the server system generates and returns customized suggestions to user.

### TECHNICAL FIELD

The present invention relates to a mobile computing device method and system for identifying a potential food allergen or irritant and, more particularly, to a method and system to identify food allergens or irritants from prepared foods prior to ordering.

### BACKGROUND ART

Thirty percent of people living in the U.S. suffer from either food allergy (a specific immune system response involving either the immunoglobulin E (IgE) antibody or T-cells), food intolerance (when the body lacks a particular enzyme to digest that food), or food sensitivity (when people have an unpleasant reaction to certain foods), according to a recent study published in The Journal of the American Medical Association.

Additionally, it is estimated that over 10% of Americans follow a restricted diet due to philosophical or religious beliefs.

All told, approximately 40% of the U.S. population follows a restricted diet, the adherence to which is problematic due to hidden ingredients in packaged food, inadequate labeling of prepared food, and uninformed restaurant personnel.

A mobile App is a computer program designed to run on smartphones, tablet computers and other mobile devices. Apps are usually available through application distribution platforms operated by the owner of the mobile operating system and are downloaded from the platform to a target device. Examples of application distribution platforms are Google Play and Apple App Store. A 2013 survey by the Division of Consumer and Community Affairs (DCCA) shows that 87% of the U.S. adult population has a mobile phone and that 61% of mobile phones are smartphones (Internet-enabled). A mobile App allows for rapid and efficient data processing and analysis, thus providing the user with customized information.

Developing Apps for mobile devices requires considering the constraints and features of these devices. Mobile devices run on battery and may have less powerful processors than personal computers. Mobile devices have more features such as location detection and cameras. Developers also have to consider a wide array of screen sizes, hardware specifications and configurations because of intense competition in mobile software and changes within each of the platforms. As part of the development process, Mobile User Interface (UI) Design is an essential in the creation of mobile Apps. Mobile UI considers constraints and contexts, screen, input, and mobility as outlines for design. The user is often the focus of interaction with their device, and the interface entails components of both hardware and software. User input allows for the users to manipulate a system, and device's output allows the system to indicate the effects of the users' manipulation.

### SUMMARY OF INVENTION

### Technical Problem

Identifying the presence of an allergen/irritant in packaged or prepared foods is a daunting task. For example, a common allergen such as egg protein may appear listed as albumin, apovitellin, globulin, livetin, lysozyme, ovalbumin, ovoglobulin, ovomucin, ovomucoid, ovotransferrin, ovovitelia, ovovitellin, silici albuminate, simplesse, or vitellin.

In a restaurant setting, the identification of allergens/irritants is left to the wait or kitchen staff, who themselves have limited reliable ways to research the composition of each ingredient included in every dish. Some large restaurant chains have started listing the major allergens (milk, egg, fish, shellfish, tree nuts, peanuts, wheat, and soybeans) found in their prepared dishes on a spreadsheet located on their website. That leaves the potential customer with the impractical task of reconciling a list of ingredients to reconstruct a menu. Additionally, some customers may not wish to voice their dietary restrictions to avoid exposing an underlying ailment or religious belief. Most often, the customer is left with a few options of “safe” choices, a solution detrimental to both the user and the restaurateur.

### Solution to Problem

The present invention provides a method and system for ordering prepared foods void of specified allergens/irritants, from a food-serving establishment.

Prior to a visit, the user sets up a profile on the App indicating his dietary restrictions and preferences. Upon entering the establishment, the registered mobile device is detected.

Using information received from the mobile device (location, time of day . . . ) and retrieved from the user profile (allergens/irritants, age, anniversary . . . ) the server system sends the user a customized greeting.

Alternatively, the user can use the App as a guest without having to set up a profile. A guest-user can either use his own device or borrow one from the establishment.

The server system processes the allergen/irritant information (whether received or retrieved) from the user and returns suggestions classified based on their compliance with the selected restrictions. A food item that is inherently void of the selected allergens/irritants gets the highest mark, a “green for go” identifier for example. A suggestion that requires minor modifications (such as to hold the tomato slice) gets a “cautious yellow” indicating the item may be ordered if slight changes are applied. A food item whereof the allergen/irritant may neither be excluded, nor substituted gets a “red for danger” identification. (One skilled in the art would appreciate that the suggestions could be classified in numerous ways—numerical or alphabetical score, percentages . . . —provided a descriptive legend accompanies the classification system). Alternatively, the user can view a physical menu enhanced with a scan-enabled feature. The desired menu item is scanned from the physical menu using the mobile device and the response (red, yellow, or green for example) is returned to the user.

The proposed app offers a continuously interactive experience. Not only does a user share his personalized meal with others on the same diet plan via his platform of choice, but the mobile device constantly feeds data to the server-system: time, location, haptic, or biometrics, for example. The social and interconnected nature of the proposed App allows for predictive and preemptive suggestions, with received and retrieved data running the algorithm in a constant loop to granularly customize each user's experience.

From the restaurateur's standpoint, the proposed App allows for full customization of menus using supplies on hand without divulging secret recipes or exact dish composition. The restaurateur may elect to integrate the present App with existing POS (point of sale) systems. The restaurateur may elect to integrate with a social media component to promote adoption of the present App.

The server-generated parameters offer new sales and marketing venues to restaurateurs. A restaurateur could elect to offer a specific offering, for example a time-limited pumpkin-flavored coffee in the fall season. Such offering could be location-based or extended to a greater geographical region. Server-generated parameters also allow for the application of predictive pricing based on prior data and supply/demand scenarios.

### Advantageous Effects of Invention

The proposed App enables users with dietary restrictions to knowledgeably order food items without having to publicly divulge said restrictions. The proposed App enables users to privately customize their diet. The proposed App relieves food establishments' staff from having to act as an intermediary between the suggested menu and desired modifications. The proposed App offers a frictionless irritant-free food ordering method.

### BRIEF DESCRIPTION OF DRAWINGS

FIG. 1 depicts the composition of the client system/mobile user interface and of the server system.

FIG. 2 depicts the exclusion/substitution algorithm of the server system.

FIG. 3 depicts a registered user experience.

FIG. 4 depicts a guest-user experience.

### DESCRIPTION OF EMBODIMENTS

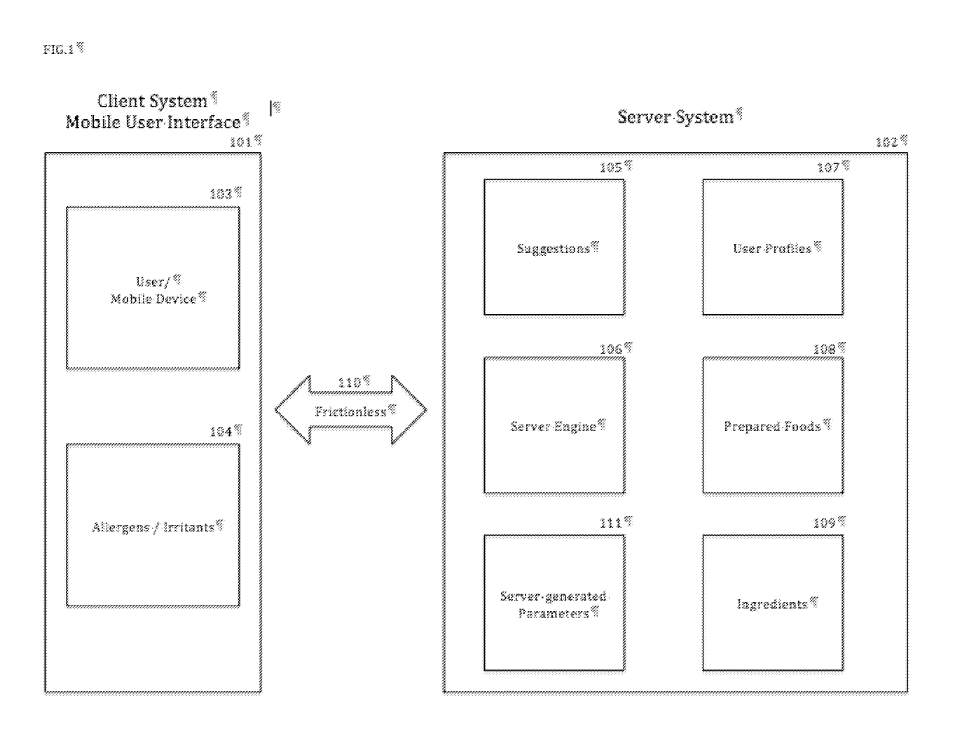

(FIG. 1) From the Mobile User Interface 101, user 103 (registered or guest) selects allergens/irritants 104, for example eggs, pork, tree nuts, dairy, etc. Server system 102 receives information from user/mobile device 103 and retrieves information from registered user 107. Server engine 106 queries exclusion parameters against ingredients 109, prepared food 108, and server-generated parameters 111 to assemble suggestions 105. Server system returns suggestions 110 to client system.

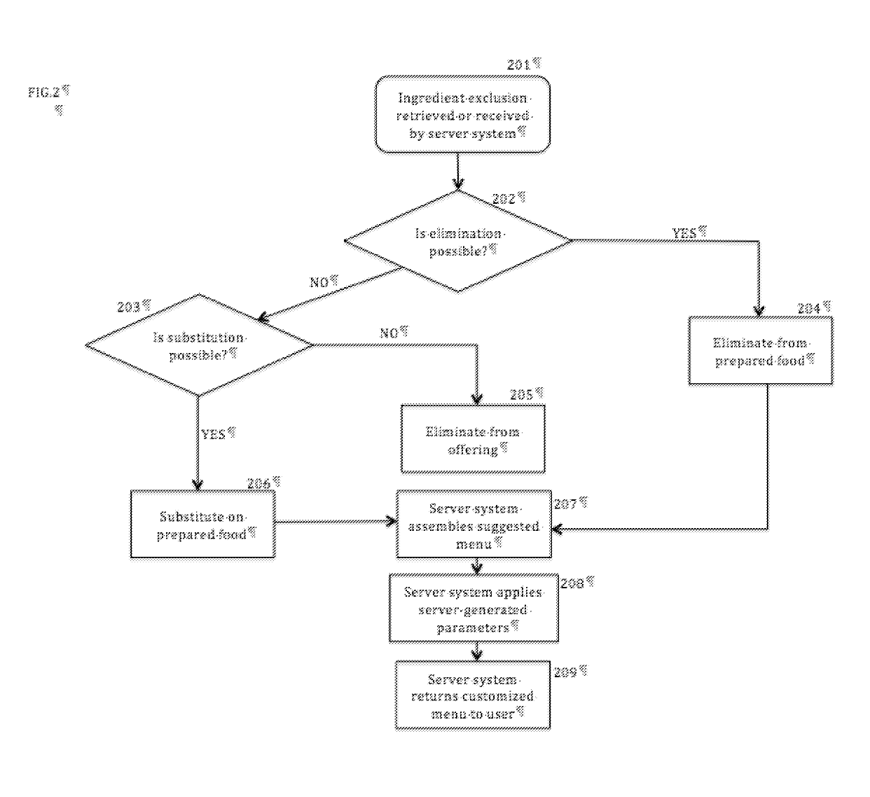

(FIG. 2) Once the server system retrieves or receives the exclusions 201, it queries whether elimination is possible 202.

If elimination of the allergen/irritant is possible without affecting the integrity of the prepared food, it is eliminated 204.

If elimination is not possible, a possible substitution is queried 203.

If substitution is not possible, the prepared food is eliminated from offering 205.

If substitution is possible, substitution is applied 206.

Server system assembles suggestions 207.

Server system applies server-generated parameters 208.

Server system returns suggestions to user 209.

For example, user indicates “tomato” as an allergen/irritant. In the case of a tuna sandwich with tomato slices, the irritant can be excluded; therefore, the system will return a suggestion of “tuna sandwich without tomatoes”. In the case of chili in tomato sauce, the irritant can neither be eliminated, nor substituted; therefore, “chili” will not be suggested to the user.

Invisible ingredients will be subjected to the same process. For example, a user indicating any and all animal products as an allergen will not receive as a suggestion a dish seasoned with Worcester Sauce™, since the condiment contains anchovies. Such granularity is essential to user's satisfaction.

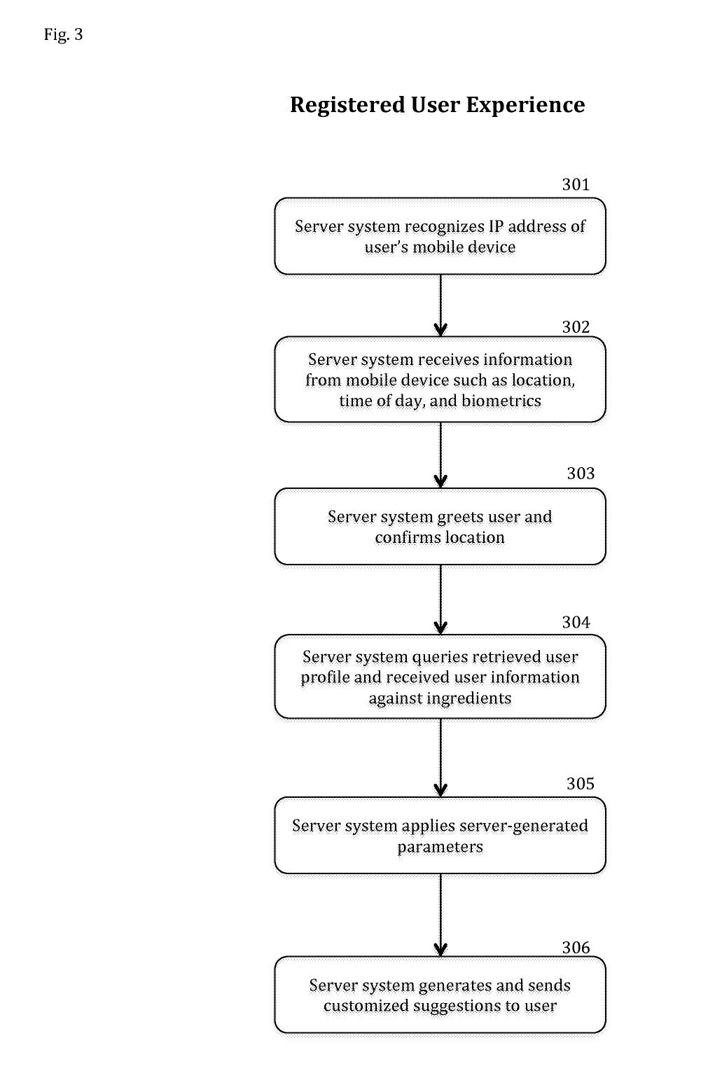

(FIG. 3) In addition to allergen/irritant avoidance, a registered user encounters a completely customized dining experience. Upon entering the establishment, the registered user's mobile device is recognized by the server system 301. The server system receives information from mobile device such as location, time of day, and biometrics 302. The server system confirms the user's location and customizes a greeting based on information retrieved from both the user profile and the server-generated parameters. Such greeting could be “Welcome back Jim, may I suggest a chilled bottle of Dom Perignon to celebrate your anniversary?” 303

The server system proceeds to query the user's dietary parameters to apply the elimination/exclusion algorithm 304. Those parameters are retrieved from the user profile and received from the mobile device.

The server system applies server-generated parameters, such as daily specials. For example, the present invention could nudge users toward certain appropriate specials by highlighting them. 305

Finally, the server system returns customized suggestions to the user. 306

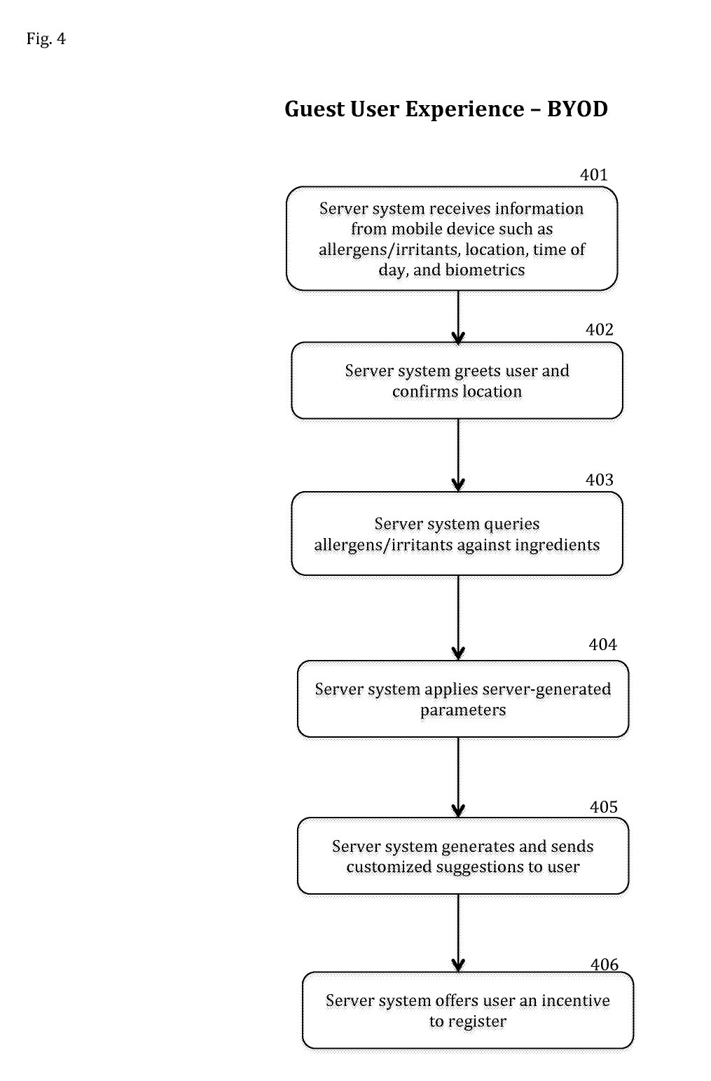

(FIG. 4) A guest user also benefits from a frictionless allergen-free ordering experience. A BYOD guest-user sends allergen/irritant information to the server system, which also receives information from the mobile device itself 401. The server system greets the user and confirms location 402, while querying dietary restrictions against ingredients 403. Server system applies server-generated parameters 404, before sending suggestions to the user 405. Finally, the user is offered an incentive (10% off next visit for example) to register 406.

### CITATION LIST PATENT LITERATURE

| | | |
|---|---|---|
| 6,990,453 | January 2006 | Wand et al |
| 8,620,753 | December 2013 | Burns et al |
| 8,249,958 | August 2012 | Robinson |
| 8,799,083 | August 2014 | Silver |

### Citation List Non Patent Literature

Ahmed T, Fuchs G J. Gastrointestinal allergy to food: A review. J Diarrhoeal Dis Res. 1997; 15(4):211-223.
Andre F, Andre C, Feknous M, Colin L, Cavagna S. Digestive permeability to different-sized molecules and to sodium cromoglycate in food allergy. Allergy Proc. 1991; 12(5):293-298.
Dominus S. The Allergy Prison. New York Times. Jun. 10, 2001.
Hafstrom I, Ringertz B, Spangberg A, et al. A vegan diet free of gluten improves signs and symptoms of rheumatoid arthritis: the effects of arthritis correlate with a reduction in antibodies to food antigens. Rheumatology. 2001; 40:1175-1179.
Helm R M, Burks A W. Mechanisms of food allergy. Current Opin Immunol. 2000; 12:647-653.
Farrell R J, Kelly C P. Celiac Sprue. N Eng J Med. 2002; 346(3):180-188.
Kweon M-N, Takahashi I, Kiyono H. New insights into mechanism of inflammatory and allergic diseases in mucosal tissues. Digestion. 2001; 63(Suppl 1):1-11.
Lichtenstein L M. Allergy and the immune system. Sci Am. 1993; 269(3):117-124.
Nossal G J V. Life, death and the immune system. Sci Am. 1993; 269(3):53-62.
Nsouli T M, Nsouli S M, Linde R E, O'Mara F, Scanlon R T, Bellanti J A. Role of food allergy in serous otitis media. Annals Allergy 1994; 73:215-219.
Perry C A, Dwyer J, Gelfand J A, Couris R R, McCloskey W W. Health effects of salicylates in foods and drugs. Nutr Rev. 1996; 54(8):225-240.
Samartin S, Marcos A, Chandra R K. Food hypersensitivity. Nutr Res. 2001; 21:473-497.
Sampson H A. Food hypersensitivity: Manifestations, diagnosis, and natural history. Food Tech. 1992; May:141-144.
Sampson H A. Food anaphylaxis. Br Med Bull. 2000; 56(4):925-935.
Sensenig J, Marrongelle J, Johnson M, Staverosky T. Treatment of migraine with targeted nutrition focused on improved assimilation and elimination. Alt Med Rev. 2001; 6(5):488-494.
Sicherer S H. Manifestations of food allergy: evaluation and management. Am Fam Phys. 1999; 59(2):415-24, 429-430.
Sicherer S H, Sampson H A. Food hypersensitiVity and atopic dermatitis: Pathophysiology, epidemiology, diagnosis and management. J Allergy Clin Immunol. 1999; 104:S114-S122.
Sinclair S. Migraine Headaches: nutritional, botanical and other alternative Approaches. Alt Med Rev. 1999; 4(2):86-95.
Soderholm J D, Perdue M H. Stress and the gastrointestinal tract II. Stress and intestinal barrier function. Am J Physiol Gastrointest Liver Physiol. 2001; G7-G13.
Taylor S L, Hefle S L. Food allergies and other food sensitivities: A publication of the Institute of Food Technologists' Expert Panel on Food Safety and Nutrition. Food Tech. 2001; 55(9):68-83.
Walker W A, Sanderson I R. Epithelial barrier function to antigens. Neuro-Immuno—Physiology Gastrointestinal Mucosa. 1992; 664:10-17.
Walker-Smith J. Food sensitivity enteropathy: Overview and update. Acta Paediatrica Japonica. 1994; 36:545-549.

We claim:

1. A method for identifying the presence of allergens/irritants in prepared food, comprising:
under control of a mobile client system,
displaying information listing potential allergens/irritants;
a method allowing user to select allergens/irritants; and
server system receiving the request;
server system storing the information of a registered user;
server system retrieving additional information previously inputted by server system administrator;
server system querying information received from client system against stored information;
server system querying information retrieved from server system;
server system assembling suggestions;
server system sending suggestions back to client system.
a. The method of claim 1 wherein the client system is located on a mobile device, such as smartphone, tablet, smart watch, wearable or implanted portable computing device.
b. The method of claim 1 wherein method allowing selection of potential allergens/irritants may be tactile, visual, oral, kinesthetic, or telepathic.
c. The method of claim 1 wherein the allergen/irritant may be captured by the mobile device's biometrics capability.
d. The method of claim 1 wherein the stored information can be integrated with an inventory, supply chain system or POS (point of sale) system.
e. The method of claim 1 wherein the client system for ordering an item comprises an identifier that identifies a user; a display component for displaying information identifying the allergens/irritants; a command that in response to performance, sends a request to a server system to eliminate or substitute the selected allergens/irritants, the request including the identifier.
f. The client system of claim 1 wherein the command may be tactile, visual, oral, kinesthetic, or telepathic.

2. A server system for generating suggested prepared foods comprising:
a user database;
an ingredients database;
a prepared food database;
server-generated parameters;
a receiving component for receiving, requests from client system;
an assembling component that retrieves from the ingredients database, the prepared food database, and the user database, and that uses the retrieved information to assemble customized suggestions; and
a frictionless means to send back the suggestions to the client system.

3. A method for eliminating allergens/irritants from prepared food using a client system, the method comprising:
displaying information identifying the allergen/irritant and displaying an indication of an action that is to be performed to exclude the identified allergen/irritant; and
in response to the indicated action being performed, sending to a server system a request to eliminate or substitute the identified allergen/irritant.
a. The method of claim 3 wherein the server system uses an identifier sent along with the request to identify additional information needed to generate customized prepared food.
b. The method of claim 3 wherein the identifier identifies the client system and the server system provides the identifier to the client system.
c. The method of claim 3 wherein the client system and server system communicate via the Internet.
d. The method of claim 3 wherein the displaying includes displaying a virtual document provided by the server system.
e. The method of claim 3 wherein the displaying may include displaying partial information supplied by the server system as to the identity of a user of the client system based on location, environment, occasion, time, or biometrics captured by the device.
